(19) United States
(12) Patent Application Publication
(10) Pub. No.: US 2026/0186137 A1
(43) Pub. Date: Jul. 2, 2026

(54) ULTRASONIC SENSOR SYSTEM FOR ACQUIRING AT LEAST ONE OBJECT IN THE VICINITY OF A VEHICLE, AND A VEHICLE COMPRISING SUCH AN ULTRASONIC SENSOR SYSTEM

(71) Applicant: Robert Bosch GmbH, Stuttgart (DE)

(72) Inventors: Attila Demeter, Budapest (HU); Tom Reimann, Bissingen An Der Teck (DE)

(21) Appl. No.: 19/131,998

(22) PCT Filed: Nov. 20, 2023
(86) PCT No.: PCT/EP2023/082339

§ 371 Date: May 22, 2025

(30) Foreign Application Priority Data
Dec. 1, 2022 (DE) 10 2022 212 949.0

(51) Int. Cl. G01S 15/931

(52) U.S. Cl. CPC G01S 15/931; G01S 2015/938

(57) ABSTRACT

An ultrasonic sensor system for acquiring at least one object in the vicinity of a vehicle. The ultrasonic sensor system includes at least a first and second ultrasonic sensor for transmitting a first and second ultrasonic signal and receiving a first, the first ultrasonic sensor and the second ultrasonic sensor being mountable on the vehicle such that a first main acquisition direction of the first ultrasonic sensor includes a first angle relative to a longitudinal axis of the vehicle and a second main acquisition direction of the second ultrasonic sensor includes a second angle relative to the longitudinal axis, wherein the first angle is smaller than the second angle. The ultrasonic sensor system is configured to select a first amplitude threshold of the first ultrasonic sensor for the first ultrasonic echo signal lower than a second amplitude threshold of the second ultrasonic sensor for the second ultrasonic echo signal.

### FIELD

The present invention relates to an ultrasonic sensor system for acquiring at least one object in the vicinity of a vehicle.

### BACKGROUND INFORMATION

Ultrasonic sensor systems for acquiring the surroundings of a vehicle are widely used in the field of surroundings monitoring for vehicles, for example as a parking assistance system. An ultrasonic sensor system according to the related art typically operates using the pulse-echo principle. An electrical signal excites the ultrasonic sensor, acting as a transducer, to vibrations on its membrane, which are emitted as sound. The sound travels through the air until it meets an object in the surroundings. The surface of the object reflects the sound, which causes backscattering in the direction of the ultrasonic sensor. When the backscattered sound hits the membrane of the ultrasonic sensor, it causes it to vibrate and creates an electrical signal at the piezo element which can be acquired and evaluated by the ultrasonic sensor system. The transit time of the sound from its emission to its return can be measured. The known speed of sound propagation can then be used to ascertain the range from the ultrasonic sensor to the backscattering object. This information can be used to find parking spaces for parking, for instance, and also to protect the side of the vehicle from impacts.

The ultrasonic sensor system typically comprises a plurality of ultrasonic sensors that are oriented differently in terms of their main acquisition direction. For example, one of the ultrasonic sensors may be directed more toward the front, whereas another ultrasonic sensor may be directed more to the side.

A problem with such an ultrasonic sensor system from the related art is that, for the detection of an object located to the side of the vehicle, an ultrasonic sensor that is directed more toward the front exhibits a large angle between the main acquisition direction and the detection direction. The amplitudes of the acquirable ultrasonic echo signals therefore become very small and the signals can no longer be evaluated by a conventional ultrasonic sensor due to the typically existing amplitude threshold.

The present invention may solve the aforementioned problems of the respective related-art systems.

### SUMMARY

The present invention relates to an ultrasonic sensor system for acquiring at least one object in the vicinity of a vehicle. According to an example embodiment of the present invention, the ultrasonic sensor system comprises at least a first ultrasonic sensor for transmitting a first ultrasonic signal and receiving a first ultrasonic echo signal and a second ultrasonic sensor for transmitting a second ultrasonic signal and receiving a second ultrasonic echo signal, wherein the first ultrasonic sensor and the second ultrasonic sensor can be mounted on the vehicle such that a first main acquisition direction of the first ultrasonic sensor includes a first angle relative to a longitudinal axis of the vehicle and a second main acquisition direction of the second ultrasonic sensor includes a second angle relative to said longitudinal axis, wherein the first angle is smaller than the second angle, and wherein the ultrasonic sensor system is configured to select a first amplitude threshold of the first ultrasonic sensor for the first ultrasonic echo signal lower than a second amplitude threshold of the second ultrasonic sensor for the second ultrasonic echo signal or to lower the first amplitude threshold and/or the second amplitude threshold in relation to a normal mode.

An advantage here is that lowering the amplitude threshold of the first ultrasonic sensor makes it possible to increase the acquisition range of the ultrasonic sensor and, for example, enables the additional use of the sensor to acquire objects that are located to the side of the vehicle, even though the first ultrasonic sensor is directed in terms of its main acquisition direction more in the direction of the longitudinal axis of the vehicle, i.e., more toward the front or rear, than the second ultrasonic sensor. This then also makes it possible to acquire and evaluate ultrasonic echo signals that arrive at the first ultrasonic sensor from a direction that is at a fairly large angle relative to the main acquisition direction. This therefore means that the sensitivity of the ultrasonic sensor is increased by lowering the amplitude threshold. Alternatively, it is also possible to lower the amplitude thresholds of both ultrasonic sensors in relation to a normal mode, which substantially concentrates the acquisition range of the respective ultrasonic sensor in the direction of the respective main acquisition direction.

The amplitude of the ultrasonic echo signal depends strongly on the detection direction in relation to the main acquisition direction of the ultrasonic sensor. The greater the difference, the lower the amplitude. The high sensitivity of the first ultrasonic sensor ensures that the first ultrasonic sensor, too, can acquire a stable signal from the side.

The vehicle can, for instance, be a car, a truck, or even an in particular motorized two-wheeler. Everything outside of the actual vehicle geometry, for example a parking area in front of, behind or next to the vehicle, can be understood as the surroundings of the vehicle.

An object can be understood to be an object in the vicinity of the vehicle, for example another vehicle, a curb or a wall. Longitudinal axis refers the axis of a body that corresponds to the direction of its largest dimension. The longitudinal axis is often also an approximate axis of symmetry of the body. In vehicles, the longitudinal axis points forwards and runs through the center of the vehicle.

According to an example embodiment of the present invention, the ultrasonic sensors can in particular comprise an ultrasonic transceiver, which is used to transmit ultrasonic signals or receive ultrasonic echo signals. The first ultrasonic sensor and the second ultrasonic sensor are mounted to a bumper or another body part of the vehicle, for example. The first ultrasonic sensor can in particular be aligned parallel or nearly parallel to the longitudinal axis of the vehicle, for instance, and the second ultrasonic sensor can be aligned perpendicular or nearly perpendicular to the longitudinal direction of the vehicle. The two ultrasonic sensors can also be disposed on a common side in relation to the longitudinal axis of the vehicle, i.e. either to the right or to the left of the longitudinal axis.

The main acquisition direction is typically understood to be the direction that is perpendicular to the membrane of the ultrasonic sensor. This is the direction in which the ultrasonic sensor can transmit and receive best; which means that the amplitudes of corresponding signals in or from this direction are the highest compared to signals having a certain angle relative to the main acquisition direction. The angle between the main acquisition direction of the ultrasonic sensor and the longitudinal axis of the vehicle is specified such that it is always minimal and can therefore be at most 90°.

Unless stated otherwise, the angles, directions, distances, spacings and ranges specified in the following are substantially in a horizontal plane relative to the vehicle.

According to an example embodiment of the present invention, the ultrasonic sensor system can also comprise a processing unit for signal processing and further distribution, which can be configured as a microcontroller, for example, and can comprise corresponding computing and storage means. The processing unit can also be configured to determine the range and direction to the object in relation to the ultrasonic sensors, for example.

The amplitude threshold can be understood to be a threshold value, wherein signal components having an amplitude that is smaller than this threshold value are not taken into further consideration by the ultrasonic sensor system, and are instead classified as not relevant. This amplitude threshold is typically used to filter out interference signals that typically have a small amplitude.

According to an example embodiment of the present invention, the ultrasonic sensor system can in particular also comprise one or more further ultrasonic sensors, wherein the amplitude threshold of the further ultrasonic sensor is adjusted such that, at a further angle between the main acquisition direction and the longitudinal axis that is smaller than the first angle, the amplitude threshold is selected such that it is further reduced in comparison with the first amplitude threshold. At a further angle that lies between the first and second angles, the amplitude threshold is accordingly selected such that it lies between the first and the second amplitude threshold. On the other hand, if the further angle is between the second angle and 90°, the amplitude threshold is selected such that it is above the second amplitude threshold.

One example embodiment of the present invention provides that the ultrasonic sensor system is configured to filter the first ultrasonic echo signal received by means of the first ultrasonic sensor, in particular by means of a Kalman filter and/or by means of a RANSAC algorithm.

An advantage of this is that interference signals, which can occur more strongly in the first ultrasonic echo signal than in the second ultrasonic echo signal due to the lower amplitude threshold of the first ultrasonic sensor, can be filtered out of the ultrasonic echo signal. Thus, as the sensitivity increases, the interference rate on the ultrasonic sensor increases as well, for example caused by noise floor, noise interference or sensor noise.

A further example embodiment of the present invention provides that the first ultrasonic sensor and the second ultrasonic sensor can be mounted on the vehicle such that the first ultrasonic sensor has a first distance from the longitudinal axis of the vehicle and the second ultrasonic sensor has a second distance from the longitudinal axis of the vehicle, wherein the first distance is smaller than the second distance.

An advantage of this is that the ultrasonic sensor disposed closer to the longitudinal axis, which can also be referred to as the inner ultrasonic sensor, the main acquisition direction of which tends to be directed more toward the front or rear relative to the vehicle, can nonetheless assist the second ultrasonic sensor disposed further away from the longitudinal axis, which can also be referred to as the outer ultrasonic sensor, the main acquisition direction of which tends to be directed more toward the side, in detecting objects to the side of the vehicle.

Another advantage is that the ultrasonic sensors have different spacings to the lateral object, as a result of which the ultrasonic echo signals can also be used to determine certain height information of the object, for example whether the object can be classified as high or low. Including the inner ultrasonic sensors in the lateral object formation, makes it possible to find stronger criteria than if only the side-facing, outer ultrasonic sensor is used to acquire the object.

Another advantage of using the inner ultrasonic sensor to acquire lateral objects is that a relatively low object, such as a curb, can still be detected even at shorter distances between the vehicle and the object when it may no longer be possible with the outer ultrasonic sensor. The outer ultrasonic sensors can only detect the curb up to a distance of approximately 50 cm between the object and the ultrasonic sensor, because, at a short distance between the sensor and curb, due to its low height, the curb is outside the vertical sensor viewing angle. However, since the inner ultrasonic sensor has a greater spacing to its own side of the vehicle, depending on the placement of the ultrasonic sensor on the vehicle, a detection distance of 50 cm from this inner ultrasonic sensor often corresponds to an actual spacing of only 10 to 20 cm from the side of the vehicle to the object. This significantly reduces the minimum detection spacing of low objects to the side of the vehicle.

The inner ultrasonic sensor typically sees lateral objects at a large angle, as a result of which the measured amplitudes can become very small. Achieving sufficient performance for the object detection of lateral objects thus necessitates a very sensitive sensor system, which is why the amplitude threshold of the inner ultrasonic sensor should be set lower than for a normal mode and particularly preferably lower than that of the outer ultrasonic sensor. The sensor field of view or the acquisition range of the ultrasonic sensor can thus be expanded to up to 180°. Ideally, the implemented amplitude thresholds still allow noise floor and sensor noise to be filtered out.

Distance here is understood to be the length of the shortest horizontal connection between the respective sensor positions and the longitudinal axis of the vehicle.

Height information refers to information for an acquired object that indicates whether the object is high or low. In this context, low is understood to be an object the height of which does not extend into the horizontal plane subtended by the ultrasonic sensors. A vehicle can typically still drive over such a low object, for example a curb, without causing damage to the vehicle. An object is classified as high, on the other hand, if the object penetrates the horizontal plane subtended by the ultrasonic sensors. Typically, a vehicle can no longer drive over such a high object, for example a wall or a post, without causing damage to the vehicle.

According to one example embodiment of the present invention, it is provided that the ultrasonic sensor system is configured to determine a first spacing of the first ultrasonic sensor to the object and a second spacing of the second ultrasonic sensor to the object and compare a difference between the first spacing and the second spacing with an existing range from the first ultrasonic sensor to the second ultrasonic sensor perpendicular to the longitudinal axis of the vehicle.

An advantage of this is that the comparison can be used to verify whether the object in the vicinity of the vehicle is in front of or behind or next to the vehicle, for instance. It can be assumed that the object is next to the vehicle if the spacing of the first ultrasonic sensor to the object substantially corresponds to the sum of the spacing of the second ultrasonic sensor to the object and an existing range from the first ultrasonic sensor to the second ultrasonic sensor perpendicular to the longitudinal axis of the vehicle.

This makes it possible to prevent incorrect object formation.

To achieve greater robustness and better performance of the verification, the test can also be averaged over the most recent x sensor activities of both ultrasonic sensors, in which case x is ascertained empirically.

Spacing here is understood to be the length of the shortest connection between the respective sensor positions and the longitudinal axis of the vehicle. If possible, this length can in particular comprise only the horizontal components of the distance.

Range is understood here to be the difference in position between the respective sensor positions perpendicular to the longitudinal axis of the vehicle. This range can in particular already be specified and stored in the ultrasonic sensor system. The range also corresponds to the difference between the first distance of the first ultrasonic sensor and the second distance of the second ultrasonic sensor relative to the longitudinal axis of the vehicle.

If the lateral object is detected by three or more ultrasonic sensors, for example, the correlation of the sensor distances perpendicular to the longitudinal axis with the difference between the measured spacings to the object can also provide an indication for the height. In the case of a high object, the horizontal distances would correspond exactly to the measured spacing differences. In the case of a low object, the measured spacing differences would be systematically smaller than the horizontal distances between the ultrasonic sensors due to the existing vertical detection angle.

According to a further example embodiment of the present invention, it is provided that the ultrasonic sensor system is configured to determine a localization of the object relative to the first ultrasonic sensor and the second ultrasonic sensor depending on the first ultrasonic echo signal and the second ultrasonic echo signal and determine a third angle between the first main acquisition direction and a first detection direction and a fourth angle between the second main acquisition direction and a second detection direction, in each case based on the localization of the object, and adjust the first ultrasonic echo signal depending on the third angle and the second ultrasonic echo signal depending on the fourth angle.

An advantage here is that adjusting the ultrasonic echo signals as a function of the respective angle between the main acquisition direction and the detection direction makes it possible to correct an inhomogeneity in the acquisition behavior of the respective ultrasonic sensor. This, for instance, allows the ultrasonic echo signals to be meaningfully compared with one another for further evaluation, for example for height classification of the object. Appropriate adjustments can be made, for example with regard to the amplitude level, the reflectivity or the correlation, because all of these represent sensor characteristics that exhibit a dependency between the main acquisition direction and the detection direction. The ultrasonic sensor system could in particular also be configured to have the ultrasonic echo signals of the two ultrasonic sensors evaluated using a machine-learned model in order to obtain a height classification of the object.

Localization is generally understood to mean the assignment to a specific spatial location. In this case, in relation to the ultrasonic sensors relative to the object.

The third and fourth angles in turn are to be understood as lying in a horizontal plane relative to the vehicle.

The detection direction is to be understood here as the direction formed by the axial connection between the ultrasonic sensor and the object.

According to a further example embodiment of the present invention, it is provided that the ultrasonic sensor system is configured to adjust the first ultrasonic echo signal and the second ultrasonic echo signal in relation to a respective amplitude level and determine height information of the object based on a comparison of an adjusted first ultrasonic echo signal with an adjusted second ultrasonic echo signal.

The advantage here is that this makes it possible to determine whether the object is high or low. This information can be used in a parking situation, for example, to determine whether the vehicle can drive over the object without causing damage to the vehicle.

For each ultrasonic echo signal, the amplitude loss resulting from the viewing angle can be added to the “raw” ultrasonic echo signal to compensate for the difference between the detection direction and the main acquisition direction, in order to then be able to compare the ultrasonic echo signals with one another. The amplitude level is increased accordingly depending on the angle.

According to a further example embodiment of the present invention, it is provided that the ultrasonic sensor system is configured to adjust the respective amplitude levels as a function of a value specified in each case for the third angle and the fourth angle.

An advantage here is that this is a simple way to adjust the amplitude levels.

The respective specified values can be linked to corresponding angles based on a previous test series, for example, and stored in a lookup table for retrieval.

According to a further example embodiment of the present invention, it is provided that the ultrasonic sensor system is configured to classify the object as high if the adjusted first ultrasonic echo signal and the adjusted second ultrasonic echo signal differ from one another by less than a specified threshold value, and/or classify the object as low if the adjusted first ultrasonic echo signal is greater than the adjusted second ultrasonic echo signal by at least the specified threshold value.

The advantage of this is that this is a simple way to determine whether the object should be classified as high or low.

The reason for this is in particular that, after adjustment, due to the smaller vertical viewing angle of the inner ultrasonic sensor compared to the outer ultrasonic sensor, the inner ultrasonic sensor has higher amplitudes for low objects than the outer ultrasonic sensor.

The present invention also relates to a vehicle, in particular a passenger car, comprising an ultrasonic sensor system according to the present invention. The first ultrasonic sensor and the second ultrasonic sensor are disposed on the vehicle such that a first main acquisition direction of the first ultrasonic sensor includes a first angle relative to the longitudinal axis and a second main acquisition direction of the second ultrasonic sensor includes a second angle relative to the longitudinal axis, wherein the first angle is smaller than the second angle.

### BRIEF DESCRIPTION OF THE DRAWINGS

FIG. 1 schematically shows a section of a vehicle configured according to an example embodiment of the present invention in a plan view using an embodiment of the ultrasonic sensor system according to the present invention for acquiring an object in the vicinity of the vehicle.

### DETAILED DESCRIPTION OF EXAMPLE EMBODIMENTS

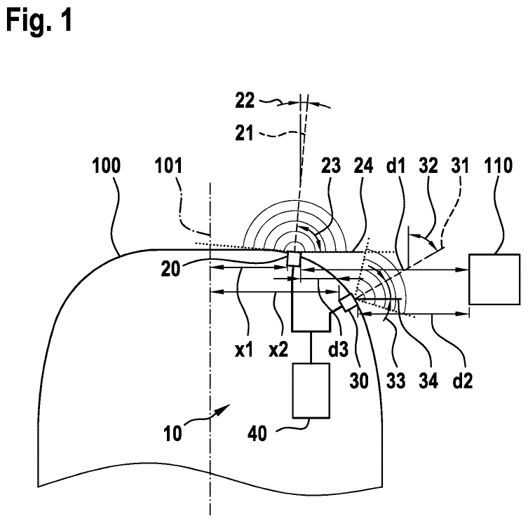

FIG. 1 schematically shows a section of a vehicle configured according to the present invention in a plan view using an embodiment of the ultrasonic sensor system according to the present invention for acquiring an object in the vicinity of the vehicle.

The FIGURE shows a schematic plan view of a section of a vehicle 100 configured according to the present invention, e.g., a passenger car, which is equipped with an embodiment of the ultrasonic sensor system 10 according to the present invention. The ultrasonic sensor system 10 comprises at least one first ultrasonic sensor 20 for transmitting a first ultrasonic signal and receiving a first ultrasonic echo signal and a second ultrasonic sensor 30 for transmitting a second ultrasonic signal and receiving a second ultrasonic echo signal.

A processing unit 40 of the ultrasonic sensor system 10 is connected to the first ultrasonic sensor 20 and the second ultrasonic sensor 30 via one or more lines. The processing unit 40 can be accordingly configured and comprises means that enable the operation of the first ultrasonic sensor 20 and the second ultrasonic sensor 30 and also enable the evaluation of the first and second ultrasonic echo signals received by the first ultrasonic sensor 20 and the second ultrasonic sensor 30. Respective means for storing, processing and evaluating received signals, which are not shown here in detail, can be provided for this purpose. The processing unit 40 can thus control the operation of the first ultrasonic sensor 20 and the second ultrasonic sensor 30 and/or query the status or receive or actively retrieve corresponding data or signals from the first ultrasonic sensor 20 and the second ultrasonic sensor 30.

The ultrasonic sensor system 10 is furthermore disposed on the vehicle 100 such that the surroundings of the vehicle 100 can be monitored by means of the ultrasonic sensor system 10. For this purpose, the first ultrasonic sensor 20 and the second ultrasonic sensor 30 are mounted to a bumper or another body part of the vehicle 100, for example. The first ultrasonic sensor 20 and the second ultrasonic sensor 30 are in particular mounted on the vehicle 100 such that a first main acquisition direction 21 of the first ultrasonic sensor includes a first angle 22 relative to a longitudinal axis 101 of the vehicle 100 and a second main acquisition direction 31 of the second ultrasonic sensor 30 includes a second angle 32 relative to the longitudinal axis 101, wherein the first angle 22 is smaller than the second angle 32. The first ultrasonic sensor 30 and the second ultrasonic sensor 30 are in particular also mounted on the vehicle 100 such that they are disposed on a common side of the longitudinal axis 101 of the vehicle 100.

The ultrasonic sensor system 10, and in particular the processing unit 40, is configured to select a first amplitude threshold of the first ultrasonic sensor 20 for the first ultrasonic echo signal lower than a second amplitude threshold of the second ultrasonic sensor 30 for the second ultrasonic echo signal, as a result of which the acquisition ranges of the first ultrasonic sensor 20 and the second ultrasonic sensor 30 are correspondingly different, wherein the acquisition ranges are represented by the fine-dashed boundaries with the curved connecting lines.

The ultrasonic sensor system 10, and in particular the processing unit 40, can also be configured to filter the first ultrasonic echo signal received by means of the first ultrasonic sensor 20, in particular by means of a Kalman filter and/or by means of a RANSAC algorithm.

In an alternative, not depicted embodiment example, the ultrasonic sensor system 10 can be configured to lower the first amplitude threshold and/or the second amplitude threshold in relation to a normal mode of the respective ultrasonic sensor 20, 30. If this is done for both ultrasonic sensors 20, 30, both acquisition ranges are thereby expanded accordingly. In such a case then it is expedient to also filter the second ultrasonic echo signal.

The first ultrasonic sensor 20 and the second ultrasonic sensor 30 can also be mounted on the vehicle 100 such that the first ultrasonic sensor 20 has a first distance x1 from the longitudinal axis 101 of the vehicle 100 and the second ultrasonic sensor 30 has a second distance x2 from the longitudinal axis 101 of the vehicle 100, wherein the first distance x1 is smaller than the second distance x2.

Additionally or alternatively, the ultrasonic sensor system 10 can be configured to determine a first spacing d1 of the first ultrasonic sensor 20 to the object 110 and a second spacing d2 of the second ultrasonic sensor 30 to the object 110, and compare a difference between the first spacing d1 and the second spacing d2 with an existing range d3 between the first ultrasonic sensor 20 and the second ultrasonic sensor 30 perpendicular to the longitudinal axis of the vehicle.

The ultrasonic sensor system 10 can also be configured to determine a localization of the object 110 relative to the first ultrasonic sensor 20 and the second ultrasonic sensor 30 depending on the first ultrasonic echo signal and the second ultrasonic echo signal and determine a third angle 23 between the first main acquisition direction 21 and a first detection direction 24 and a fourth angle 33 between the second main acquisition direction 31 and a second detection direction 34, in each case based on the localization of the object 110, and adjust the first ultrasonic echo signal depending on the third angle 23 and the second ultrasonic echo signal depending on the fourth angle 33.

The ultrasonic sensor system 10 can in particular be configured to adjust the first ultrasonic echo signal and the second ultrasonic echo signal in relation to a respective amplitude level and determine height information of the object 110 based on a comparison of an adjusted first ultrasonic echo signal with an adjusted second ultrasonic echo signal. The ultrasonic sensor system 10 can be configured to adjust the respective amplitude levels as a function of a value specified in each case for the third angle 23 and the fourth angle 33.

The ultrasonic sensor system 10 can in particular be configured to classify the object 110 as high if the adjusted first ultrasonic echo signal and the adjusted second ultrasonic echo signal differ from one another by less than a specified threshold value and/or to classify the object 110 as low if the adjusted first ultrasonic echo signal is greater than the adjusted second ultrasonic echo signal by at least the specified threshold value.

1-9. (canceled)

10. An ultrasonic sensor system for acquiring at least one object in a vicinity of a vehicle, the ultrasonic sensor system comprising:
at least a first ultrasonic sensor configured to transmit a first ultrasonic signal and receive a first ultrasonic echo signal; and
a second ultrasonic sensor configured to transmit a second ultrasonic signal and receive a second ultrasonic echo signal;
wherein the first ultrasonic sensor and the second ultrasonic sensor can be mounted on the vehicle such that a first main acquisition direction of the first ultrasonic sensor includes a first angle relative to a longitudinal axis of the vehicle, and a second main acquisition direction of the second ultrasonic sensor includes a second angle relative to the longitudinal axis, wherein the first angle is smaller than the second angle, and
wherein the ultrasonic sensor system is configured: (i) to select a first amplitude threshold of the first ultrasonic sensor for the first ultrasonic echo signal lower than a second amplitude threshold of the second ultrasonic sensor for the second ultrasonic echo signal, or (ii) to lower the first amplitude threshold and/or the second amplitude threshold in relation to a normal mode.

11. The ultrasonic sensor system according to claim 10, wherein the ultrasonic sensor system is configured to filter, using a Kalman filter and/or using a random sample consensus (RANSAC) algorithm, the first ultrasonic echo signal received using the first ultrasonic sensor.

12. The ultrasonic sensor system according to claim 10, wherein first ultrasonic sensor and the second ultrasonic sensor can be mounted on the vehicle such that the first ultrasonic sensor has a first distance from the longitudinal axis of the vehicle and the second ultrasonic sensor has a second distance from the longitudinal axis of the vehicle, wherein the first distance is smaller than the second distance.

13. The ultrasonic sensor system according to claim 12, wherein the ultrasonic sensor system is configured to determine a first spacing of the first ultrasonic sensor to the object and a second spacing of the second ultrasonic sensor to the object, and compare a difference between the first spacing and the second spacing with an existing range from the first ultrasonic sensor to the second ultrasonic sensor perpendicular to the longitudinal axis of the vehicle.

14. The ultrasonic sensor system according to claim 12, wherein the ultrasonic sensor system is configured to determine a localization of the object relative to the first ultrasonic sensor and the second ultrasonic sensor depending on the first ultrasonic echo signal and the second ultrasonic echo signal, and determine a third angle between the first main acquisition direction and a first detection direction, and a fourth angle between the second main acquisition direction and a second detection direction, in each case based on the localization of the object, and adjust the first ultrasonic echo signal depending on the third angle and the second ultrasonic echo signal depending on the fourth angle.

15. The ultrasonic sensor system according to claim 14, wherein the ultrasonic sensor system is configured to adjust the first ultrasonic echo signal and the second ultrasonic echo signal in relation to a respective amplitude level and determine height information of the object based on a comparison of an adjusted first ultrasonic echo signal with an adjusted second ultrasonic echo signal.

16. The ultrasonic sensor system according to claim 15, wherein the ultrasonic sensor system is configured to adjust the respective amplitude levels based on a value specified in each case for the third angle and fourth angle.

17. The ultrasonic sensor system according to claim 15, wherein the ultrasonic sensor system is configured to classify the object as high when the adjusted first ultrasonic echo signal and the adjusted second ultrasonic echo signal differ from one another by less than a specified threshold value, and/or classify the object as low when the adjusted first ultrasonic echo signal is greater than the adjusted second ultrasonic echo signal by at least the specified threshold value.

18. A vehicle, comprising:
an ultrasonic sensor system configured to acquire at least one object in a vicinity of a vehicle, the ultrasonic sensor system including:
at least a first ultrasonic sensor configured to transmit a first ultrasonic signal and receive a first ultrasonic echo signal, and
a second ultrasonic sensor configured to transmit a second ultrasonic signal and receive a second ultrasonic echo signal,
wherein the first ultrasonic sensor and the second ultrasonic sensor are disposed on the vehicle such that a first main acquisition direction of the first ultrasonic sensor includes a first angle relative to a longitudinal axis of the vehicle, and a second main acquisition direction of the second ultrasonic sensor includes a second angle relative to the longitudinal axis, wherein the first angle is smaller than the second angle, and
wherein the ultrasonic sensor system is configured: (i) to select a first amplitude threshold of the first ultrasonic sensor for the first ultrasonic echo signal lower than a second amplitude threshold of the second ultrasonic sensor for the second ultrasonic echo signal, or (ii) to lower the first amplitude threshold and/or the second amplitude threshold in relation to a normal mode.
